(19) United States
(12) Patent Application Publication
(10) Pub. No.: US 2018/0180432 A1
(43) Pub. Date: Jun. 28, 2018

(54) VEHICULAR TRAFFIC PATTERN APPLICATION

(71) Applicant: Ford Global Technologies, LLC, Dearborn, MI (US)

(72) Inventors: Gopichandra Surnilla, West Bloomfield, MI (US); Dimitar Petrov Filev, Novi, MI (US); John Ottavio Michelini, Sterling Heights, MI (US)

(21) Appl. No.: 15/389,397

(22) Filed: Dec. 22, 2016

(51) Int. Cl. G01C 21/34; G08G 1/16; G08G 1/0968

(52) U.S. Cl. CPC G01C 21/3492; G01C 21/3415; B60K 35/00; G08G 1/0968; G08G 1/167

(57) ABSTRACT

Disclosed is a vehicle including: motor(s), sensors, processor(s) configured to: (a) periodically update a table with present coordinates; (b) compare the tabled coordinates to an intersection boundary; (c) select a portion of the tabled coordinates based on the comparison; (d) transmit the selected portion to server(s). The processor(s) may configured to periodically connect a series of the tabled coordinates with a virtual and continuous line and determine whether any portion of the line falls within the intersection boundary, and if so, select the portion of the tabled coordinates.

### TECHNICAL FIELD

This disclosure relates to, among other things, calculating and applying traffic patterns.

### BACKGROUND

Drivers typically use navigation programs to route. The navigation programs may be outdated and include illegal driving maneuvers (e.g., the navigation programs may fail to update when right turns in a certain lane become prohibited). The navigation programs may lack data related to traffic light timings. As such, when routing based on existing navigation programs, drivers may perform illegal driving maneuvers (e.g., turns) and take routes that are slowed by unfavorable traffic light timings.

### SUMMARY

Disclosed is a vehicle including: motor(s), sensors, processor(s) configured to: (a) periodically update a table with present coordinates; (b) compare the tabled coordinates to an intersection boundary; (c) select a portion of the tabled coordinates based on the comparison; (d) transmit the selected portion to an external unit. The processor(s) may configured to periodically connect a series of the tabled coordinates with a virtual and continuous line and determine whether any portion of the line falls within the intersection boundary, and if so, select the portion of the tabled coordinates. The processor(s) of the disclosed vehicle may be further configured to: receive a series of entries, comprising coordinates and timestamps, from a first vehicle; select entries corresponding to an identified traffic intersection based on the coordinates; based on the selected entries, determine a driving maneuver of the first vehicle through the intersection and an intersection timing associated therewith.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a block diagram of a vehicle computing system.

FIG. 2 is a schematic top plan view of a host vehicle including the vehicle computing system.

FIG. 3 is a schematic top plan view of an intersection.

FIG. 4 is a table of driving data.

FIG. 5 is a schematic top plan view of a portion of the intersection overlaid with coordinates of the host vehicle.

FIG. 6 is a schematic top plan view of the portion of the intersection overlaid with a plurality of line segments connecting coordinates of the host vehicle.

FIG. 7 is a block diagram of operations performed by an one or more external processing units (EPU) in communication with the host vehicle.

FIG. 8 is a link table having formal linking entries and timing entries.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present, as one option, and mutually exclusive alternatives as another option. In other words, the conjunction “or” should be understood to include “and/or” as one option and “either/or” as another option.

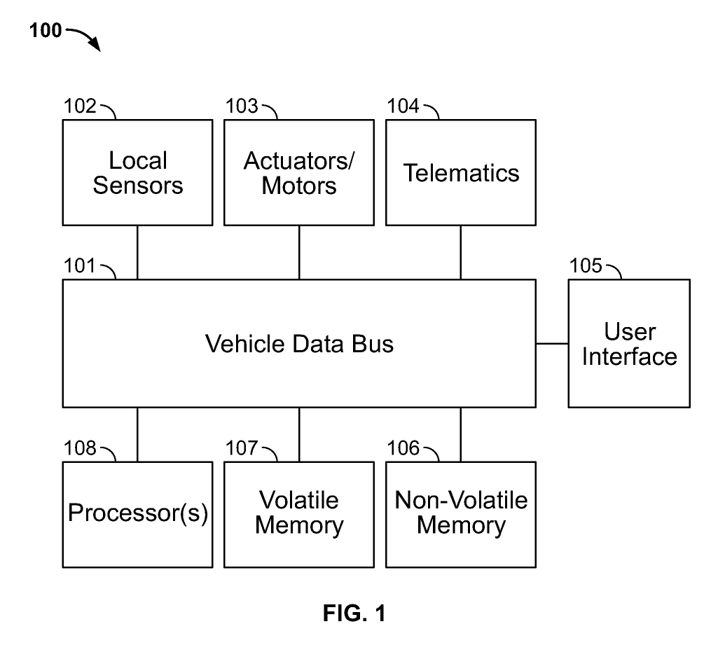

FIG. 1 shows a computing system 100 of host vehicle 200. Host vehicle 200 is connected, meaning that host vehicle 200 is configured to (a) receive wireless data from external entities (e.g., infrastructure, servers, other connected vehicles) and (b) transmit wireless data to external entities. Host vehicle 200 may be autonomous, semi-autonomous, or manual. Host vehicle 200 includes a motor, a battery, at least one wheel driven by the motor, and a steering system configured to turn the at least one wheel about an axis. Host vehicle 200 may be fossil fuel powered (e.g., diesel, gasoline, natural gas), hybrid-electric, fully electric, fuel cell powered, etc.

Vehicles are described, for example, in U.S. patent application Ser. No. 15/076,210 to Miller, U.S. Pat. No. 8,180,547 to Prasad, U.S. patent application Ser. No. 15/186,850 to Lavoie, U.S. Patent Publication No. 2016/0117921 to D'Amato, and U.S. patent application Ser. No. 14/972,761 to Hu, all of which are hereby incorporated by reference in their entireties. Host vehicle 200 may include any of the features described in Miller, Prasad, Lavoie, D'Amato, and Hu.

Computing system 100 resides in host vehicle 200. Computing system 100, among other things, enables automatic control of mechanical systems within host vehicle 200 and facilitates communication between host vehicle 200 and external entities (e.g., connected infrastructure, the Internet, other connected vehicles). Computing system 100 includes a data bus 101, one or more processors 108, volatile memory 107, non-volatile memory 106, user interfaces 105, a telematics unit 104, actuators and motors 103, and local sensors 102.

Data bus 101 traffics electronic signals or data between the electronic components. Processor 108 performs operations on electronic signals or data to produce modified electronic signals or data. Volatile memory 107 stores data for near-immediate recall by processor 108. Non-volatile memory 106 stores data for recall to the volatile memory 107 and/or the processor 108. Non-volatile memory 106 includes a range of non-volatile memories including hard drives, SSDs, DVDs, Blu-Rays, etc. User interface 105 includes displays, touch-screen displays, keyboards, buttons, and other devices that enable user interaction with the computing system. Telematics unit 104 enables both wired and wireless communication with external entities via Bluetooth, cellular data (e.g., 3G, LTE), USB, etc.

Actuators/motors 103 produce tangible results. Examples of actuators/motors 103 include fuel injectors, windshield wipers, brake light circuits, transmissions, airbags, motors mounted to sensors (e.g., a motor configured to swivel a local sensor 102), engines, power train motors, steering, blind spot warning lights, etc.

Local sensors 102 transmit digital readings or measurements to processors 108. Examples of local sensors 102 include temperature sensors, rotation sensors, seatbelt sensors, speed sensors, cameras, lidar sensors, radar sensors, infrared sensors, ultrasonic sensors, clocks, moisture sensors, rain sensors, light sensors, etc. It should be appreciated that any of the various electronic components of FIG. 1 may include separate or dedicated processors and memory. Further detail of the structure and operations of computing system 100 is described, for example, in Miller, Prasad, Lavoie, and Hu.

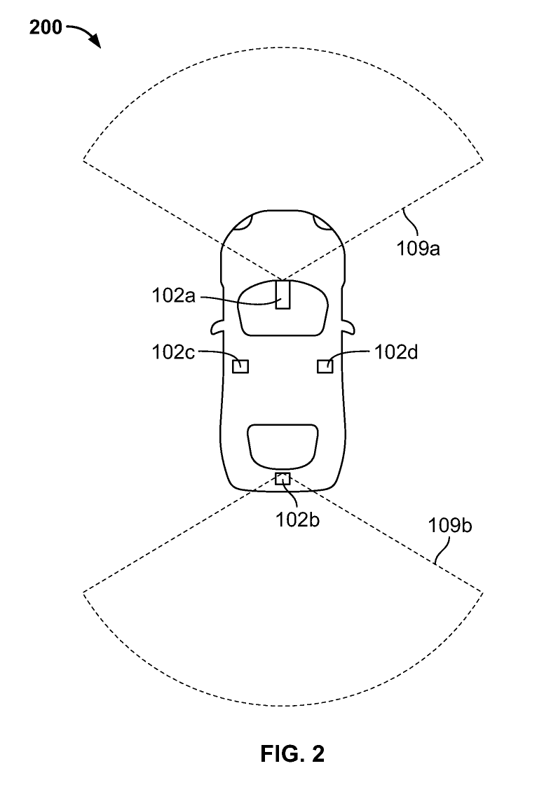

FIG. 2 generally shows and illustrates host vehicle 200, which includes computing system 100. Some of the local sensors 102 are mounted on an exterior of host vehicle 200 (others are located inside the vehicle 200). Local sensor 102a is configured to detect objects leading the vehicle 200. Local sensor 102b is configured to detect objects trailing the vehicle 200 as indicated by trailing sensing range 109b. Left sensor 102c and right sensor 102d are configured to perform similar functions for the left and right sides of the vehicle 200.

As previously discussed, local sensors 102a to 102d may be ultrasonic sensors, lidar sensors, radar sensors, infrared sensors, cameras, microphones, and any combination thereof, etc. Host vehicle 200 includes a plurality of other local sensors 102 located in the vehicle interior or on the vehicle exterior. Local sensors 102 may include any or all of the sensors disclosed in Miller, Prasad, Lavoie, D'Amato, and Hu.

Host vehicle 200 may include a blind spot warning system, as is known in the art. A blind spot warning system detects when an external vehicle occupies a certain zone with respect to host vehicle, the zone being predetermined at the time of manufacturing and representing a blind spot of host vehicle 200. When an external vehicle occupies the certain zone, host vehicle 200 may (a) activate one or more dedicated blind spot warning lights located on host vehicle dash, (b) display a message on a host vehicle display, and/or (c) control steering to prevent host vehicle 200 from changing lanes and colliding with the external vehicle.

It should be appreciated that host vehicle 200 is configured to perform the methods and operations described herein. In some cases, host vehicle 200 is configured to perform these functions via computer programs stored on volatile 107 and/or non-volatile 106 memories of computing system 100.

One or more processors are “configured to” perform a disclosed method step, block, or operation, at least when at least one of the one or more processors is in operative communication with memory storing a software program with code or instructions embodying the disclosed method step or block. Further description of how processors, memory, and software cooperate appears in Prasad. According to some embodiments, a mobile phone or external server(s) in operative communication with host vehicle 200 perform some or all of the methods and operations discussed below.

According to various embodiments, host vehicle 200 includes some or all of the features of vehicle 100a of Prasad. According to various embodiments, computing system 100 includes some or all of the features of VCCS 102 of FIG. 2 of Prasad. According to various embodiments, host vehicle 200 is in communication with some or all of the devices shown in FIG. 1 of Prasad, including nomadic or mobile device 110, communication tower 116, telecom network 118, Internet 120, and data processing center (i.e., one or more servers) 122. Each of the entities described in this application (e.g., the connected infrastructure, the other vehicles, mobile phones, servers) may share any or all of the features described with reference to FIGS. 1 and 2.

The term “loaded vehicle,” when used in the claims, is hereby defined to mean: “a vehicle including: a motor, a plurality of wheels, a power source, and a steering system; wherein the motor transmits torque to at least one of the plurality of wheels, thereby driving the at least one of the plurality of wheels; wherein the power source supplies energy to the motor; and wherein the steering system is configured to steer at least one of the plurality of wheels.” Host vehicle 200 may be a loaded vehicle.

The term “equipped electric vehicle,” when used in the claims, is hereby defined to mean “a vehicle including: a battery, a plurality of wheels, a motor, a steering system; wherein the motor transmits torque to at least one of the plurality of wheels, thereby driving the at least one of the plurality of wheels; wherein the battery is rechargeable and is configured to supply electric energy to the motor, thereby driving the motor; and wherein the steering system is configured to steer at least one of the plurality of wheels.” Host vehicle 200 may be an equipped electric vehicle.

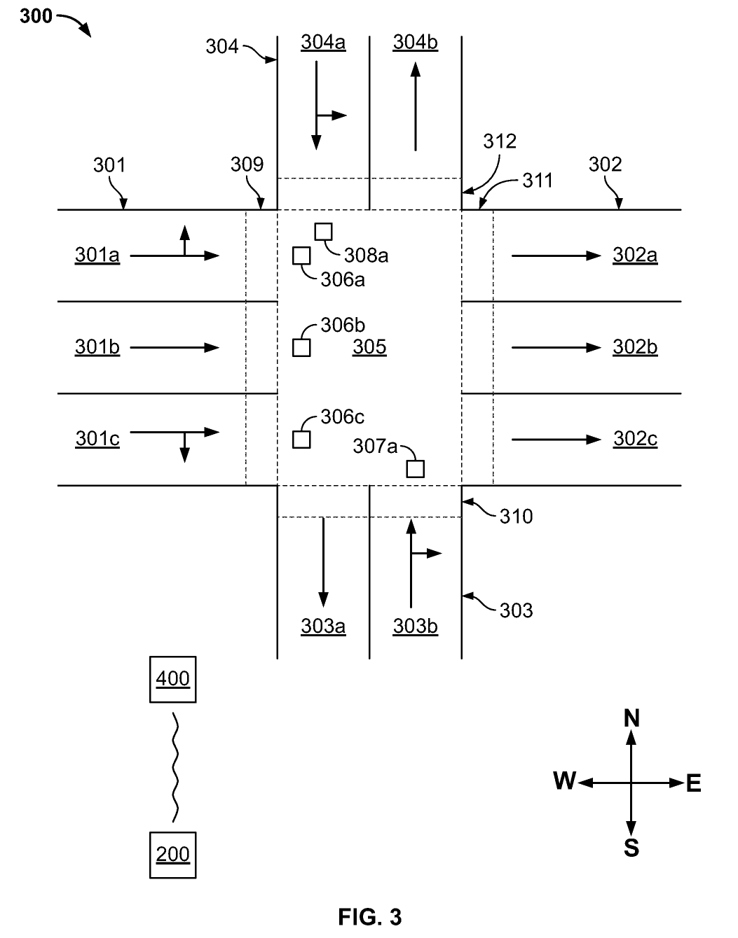

Referring to FIG. 3, first road 301, 302 meets second road 303, 304 at intersection 300. First road 301, 302 is one-way eastbound. Second road 303, 304 is northbound and southbound. Crossing area 305 divides first road 301, 302 into a first section 301 and a second section 302. Crossing area 305 divides second road 303, 304 into a first section 303 and a second section 304. First road 301, 302 includes pedestrian crossings 309, 311. Second road 303, 304 includes pedestrian crossings 310, 312.

Road section 301 includes eastbound lanes 301a, 301b, 301c. Road section 302 includes eastbound lanes 302a, 302b, 302c. Road section 303 includes southbound lane 303a and northbound lane 303b. Road section 304 includes southbound lane 304a and northbound lane 304b. Traffic in the lanes is allowed to flow according to the directional arrows of FIG. 3 (not labeled).

One or more first traffic lights 306a, 306b, 306c may control traffic in lanes 301a, 301b, 301c. The first traffic lights may include at least three different lights (red, yellow, and green). The first lights may include at least five different lights (red, yellow, green, green left turn arrow, green right turn arrow). The first traffic light may include at least six different traffic lights (red, yellow, green, green left turn arrow, red left turn arrow, green right turn arrow).

One or more second traffic lights 307a may control traffic in lane 303b. The second traffic lights may include at least three different lights (red, yellow, and green). The second traffic lights may include at least four different lights (red, yellow, green, green right turn arrow).

One or more third traffic lights 308a may control traffic in lane 304a. The third traffic lights may include at least three different lights (red, yellow, and green). The third traffic lights may include at least five different lights (red, yellow, green, green left turn arrow, red left turn arrow).

One or more external processing units 400 are configured to periodically receive driving data from a plurality of host vehicles 200 to (a) determine allowable traffic flow each lane and (b) determine signal timing of each lane. Upon determining signal timing of the lanes, host vehicles 200 and/or the one or more external processing units 400 (EPU) may optimize routes based on the signal timings of a plurality of intersections. EPU 400 may be one or more vehicles (e.g., one or more external vehicles configured to perform the same functions and operations as host vehicle 200 and configured to wirelessly communicate with host vehicle 200). EPU 400 may be one or more servers. EPU 400 may be one or more external host vehicles in operative communication with one or more servers. Put differently, host vehicle 200 may be configured to act as an EPU 400, optionally in conjunction with one or more servers, for other (i.e., external) host vehicles.

At block 702, EPU 400 receives a base road map. The base road map includes road geometry and position, individual lane geometry and position of each road, and intersection geometry and position. The base road map may be provided to external server 400 as one or more vector files, as opposed to one or more raster files. The base road map may include allowable driving maneuvers for each lane. As such, lanes may be stored as objects and allowable driving maneuvers may be stored as attributes of the objects. As stated above, the direction arrows of FIG. 3 illustrate allowable driving maneuvers for each lane (e.g., vehicles in lane 301a may turn left or go straight, vehicles in lane 301b may only go straight, vehicles in lane 301c may turn right or go straight).

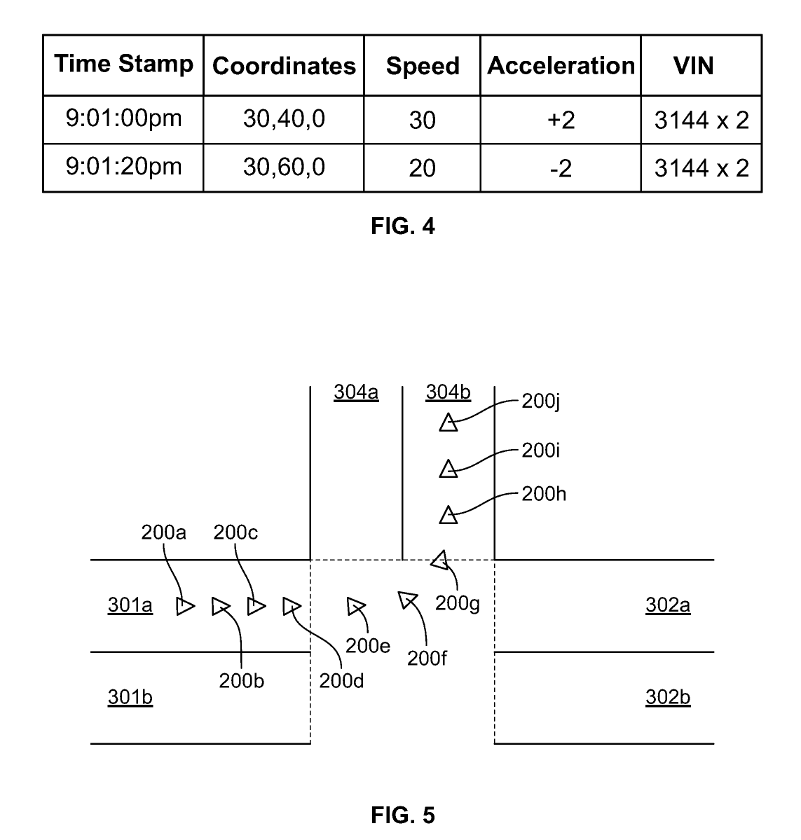

At block 704, EPU 400 receives driving data from host vehicle 200. The driving data may include entries listing coordinates of host vehicle 200 at certain moments in time. Put differently, and as shown in FIG. 4, host vehicle 200 is configured to store, and then transmit a series of entries. Each entry includes a timestamp, a speed, an acceleration, and a unique vehicle identifier (e.g., a VIN number). If EPU 400 includes a vehicle (e.g., a second host vehicle), then the second host vehicle 200 may receiving the driving data from host vehicle 200 via inter-vehicle communication (e.g., DSRC).

Host vehicle 200 may record new entries at predetermined intervals (e.g., fixed intervals such as every 0.5 seconds). According to one embodiment, the predetermined intervals are variable and positively correlated with a speed and/or an acceleration of host vehicle 200. For example, at higher speeds host vehicle 200 may decrease the predetermined intervals such that new coordinate entries are generated rapidly. At lower speeds, host vehicle 200 may increase the predetermined intervals such that new entries are generated slowly.

According to one embodiment, when host vehicle 200 is stopped (i.e., has a speed of zero), only one entry corresponding to the stopping point is recorded. The next entry is delayed until host speed exceeds zero. According to some embodiments, and for reasons that will become apparent below, host vehicle 200 may be configured to automatically generate a timestamp when (i) a sign of acceleration changes (i.e., positive to zero, zero to negative, negative to positive, etc.) and/or (ii) speed increases from zero. To account for cases where a vehicle inches forward while stuck in traffic, the entry may be discarded if host vehicle 200 fails to maintain the nonzero speed for at least a predetermined amount of time, if host vehicle 200 fails to accelerate to at least a predetermined speed within a predetermined amount of time after having the nonzero speed, and/or if host vehicle 200 decelerates within a predetermined time of having the nonzero speed.

Host vehicle 200 may parse and organize the entries prior to transmitting the entries to EPU 400. As stated above, entries may be recorded at fixed time intervals (e.g., every two seconds). Host vehicle 200 may delete (or at least not transmit) redundant entries. Redundant entries occur when a series of consecutive entries include the same coordinates (the “same” coordinates contemplates coordinates that are substantially similar, such as coordinates that differ by less than a predetermined maximum percentage), such as when host vehicle 200 is stopped at a traffic light. As such, host vehicle 200 may keep a first one of the consecutive redundant entries, and delete (or at least not transmit) the subsequent consecutive redundant entries.

Host vehicle 200 may be configured to only transmit entries corresponding to an intersection passing. Each intersection passing may include and/or consist of a beginning, middle, and end. Consider a case where host vehicle 200 travels in lane 301c for one minute, occupies crossing area 305 for one second, and then travels in lane 303a for one minute. Host vehicle 200 may recognize self occupation of crossing area 305, and then select, for transmission, a predetermined number of entries preceding occupation of crossing area 305, any entries corresponding to occupation of crossing area 305, and a predetermined number of entries following occupation of crossing area 305. The boundaries of crossing area 305 may be referred to as an intersection boundary. Alternatively, host vehicle 200 may recognize self occupation of a virtual boundary surrounding intersection 300 (also referred to as an intersection boundary). Host vehicle 200 may then prepare and transmit entries corresponding to a time when host vehicle 200 occupied the virtual boundary.

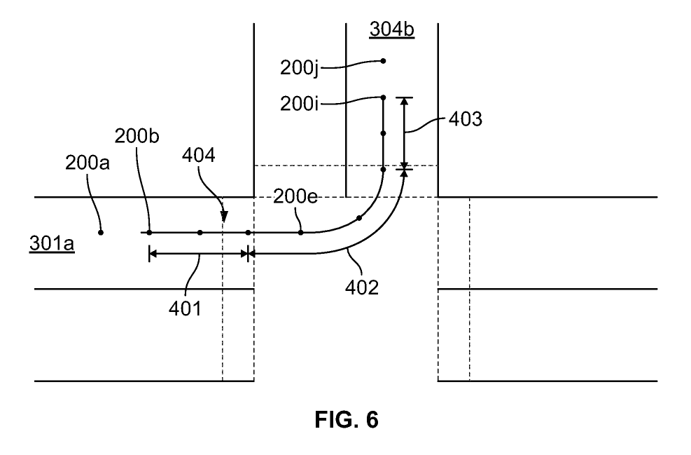

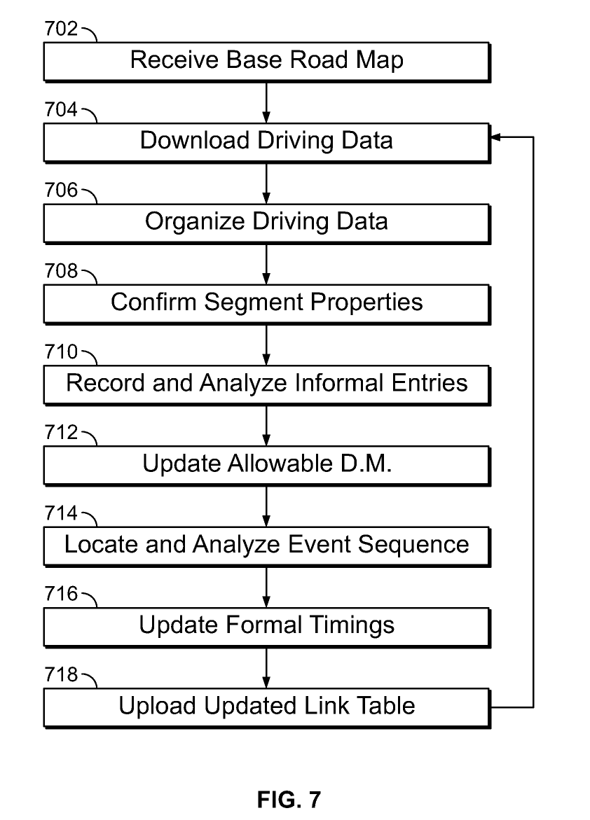

The predetermined number of entries may include and/or only include entries (a) within a certain time range of occupation of crossing area 305 and/or (b) within a certain distance of crossing area 305. FIG. 5 shows ten entries 200a to 200j made by host vehicle 200. With reference to FIG. 6, some of the entries (e.g., entries 200a and 200j) may fall outside of the intersection passing 401, 402, 403.

As one example, host vehicle 200 may determine whether crossing area 305 has been occupied by drawing a continuous line 404 connecting coordinates of a plurality of entries 200a to 200j (see FIG. 6). Host vehicle 200 may determine whether any coordinates of the continuous line fall within a boundary of crossing area 305 or the virtual boundaries, with reference to the base map (which may also be stored on host vehicle 200). Alternatively, host vehicle 200 may determine self-occupation of an intersection upon self-occupation of a new non-related lane. Related lanes may be lanes carrying parallel traffic between adjacent intersections, but not lanes separated by intersections (e.g., lanes 301a, 301b, 301c are all aligned with each other but non-aligned with any of lanes 302a, 302b, 302c).

Host vehicle 200 may only transmit the driving data (including the entries) to EPU 400 in response to a request from EPU 400. EPU 400 may list identities of certain intersections 300. The identities may include coordinates virtual intersection boundaries. EPU 400 may list certain identities of lanes and/or certain driving maneuvers of certain lanes). Host vehicle 200 may search through the list and only transmit driving data that has been requested by EPU 400. For example, if EPU 400 has only requested data corresponding to an intersection passing where a vehicle begins in lane 301a, then host vehicle 200 will not transmit driving data corresponding to an intersection passing beginning in lane 301b. As another example, if EPU 400 has listed boundaries of a first intersection 300, but not a second intersection 300, then host vehicle 200 may transmit driving data related to first intersection 300, but not second intersection 300.

When host vehicle 200 does not parse and organize the driving data, and according to some embodiments, even when host vehicle 200 does parse and organize the driving data upon receiving the driving data, EPU 400 may parse and organize the driving data to determine when a host vehicle 200 has passed through an intersection 300. More specifically, and at block 706, EPU 400 may perform any of the computations described above with reference to host vehicles 200 to generate entry sets, each of the entry sets including the beginning (the time prior to passing through the crossing area 305 of the intersection 300 when host vehicle 200 is in a road lane), the middle (the time passing through the crossing area 305 of the intersection 300), and the end (the time after passing through the crossing area and host vehicle 200 is in a road lane) of an intersection passing. Each entry set may correspond to a different intersection 300. As stated above, referring to a crossing area 305 is not necessary, and EPU 400 may determine an intersection passing with reference to host vehicle 200 occupying a non-related late and/or with reference to any virtual boundary.

Whether the parsing and organization is performed by host vehicle 200, or EPU 400, EPU 400 eventually receives entry sets from a plurality of host vehicles 200 corresponding to a plurality of intersections 300. At block 708, EPU 400 may connect coordinates 200b to 200i (200a and 200j fall outside of the intersection passing) of an entry set with a continuous line 404 (see FIG. 6). EPU 400 performs this process for some or all of the plurality of entry sets. EPU 400 may segment the continuous line into beginning 401, middle 402, and end segments 403. The beginning segment 401 may include a portion of the continuous line prior to entry of host vehicle 200 into crossing area 305. The middle segment 402 may include the portion of the continuous line within outer boundaries of crossing area 305. The end segment 403 may include the portion of the continuous lane after exit of host vehicle 200 from crossing area.

At block 708, EPU 400 may confirm that the beginning segment is not self-intersecting and is confined within the boundaries of a single lane. EPU 400 confirms that the middle segment is not self-intersecting. EPU 400 confirms that the end segment is not self-intersecting and is confined within boundaries of a single lane. If any of the above conditions are not confirmed, then EPU 400 may discard the entry set. If the above conditions are confirmed, then EPU 400 may generate an informal linking entry between the beginning lane and the end lane.

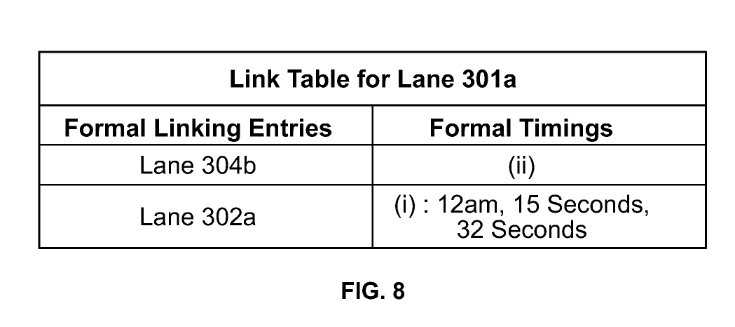

At block 710, EPU 400 updates a link table to include the informal linking entry between the beginning lane and the end lane. Each lane of each intersection of the base map may be associated with a separate and distinct link table. As shown in FIG. 8, each link table may include allowable driving maneuvers (also called formal linking entries) paired with formal timing entries (discussed below).

The formal linking entries (also called allowable driving maneuvers) may be based on a collection of informal linking entries from a plurality of host vehicles 200. A formal linking entry may be recognized only when a certain quantity of informal linking entries from a certain quantity of unique vehicles have been generated within a certain timespan. The certain timespan may be different for each intersection 300. The certain timespan may be set such that at a predetermined number of informal entries are considered (e.g., 280 informal entries). Thus, if intersection 300 received 280 informal entries every 6.5 days, then the timespan would be 6.5 days. If intersection 300 received 280 informal entries every 30 days, then the timespan would be 30 days.

As one example, EPU 400 may count the total number of informal linking entries in a link table (as stated above, each lane has a separate link table) having a timestamp within the certain timespan. EPU 400 may then group the relevant informal linking entries by ending lane and count the total number in each group.

Consider the case when there are 280 informal entries beginning at lane 301a within the past 30 days. 180 of the entries end at lane 302a. 80 of the entries end at lane 304b. 15 of the entries end at lane 302b, 4 of the entries end at lane 303a, and 1 of the entries ends at lane 304a. EPU 400 requires at least 3% of the total entries to end at a certain lane to generate a formal linking entry. Here, formal linking entries would be made between lane 301a and (a) lane 302a, (b) lane 304b, and (c) lane 302b. No formal linking entries would be made between lane 301a and (d) lane 303a and (e) lane 304a. Formal linking entries (a) and (b) are correct. Formal linking entry (c), however, is incorrect (a vehicle may not lane-change in an intersection).

As a remedy, EPU 400 may limit formal linking entries having parallel ending lanes. Here, lanes 302a and 302b are parallel ending lanes with respect to lane 301a. As such, EPU 400 may determine which of lanes 302a and 302b has a greater number of informal linking entries. Lane 302a has 200 informal entries, whereas lane 302b has 15 informal entries. As such, and as shown in FIG. 8, EPU 400 may, at block 712, issue the formal linking entry between lane 301a and lane 302a, but not issue the formal linking entry between lane 301a and lane 302b.

The base map may be configured such that each lane is an object and the formal entries are attributes of the object. As shown in FIG. 3, new lanes may begin after an intersection 300 (e.g., lane 302a is identified being different than lane 301a). EPU 400 may periodically issue updates of the base map to revise the attributes (e.g., the link table). Host vehicle 200 may include a navigation program enabling a user to enter a starting point and a destination (the starting point may be automatically set based on a current location of host vehicle 200). Host vehicles of EPU 400 may also include the navigation program.

The navigation program may find one or more routes between the starting point and the destination. To find the one or more routes, the navigation program may reference the base map, including the attributes (e.g., link tables) of the intersections of the base map. The route may be set such that host vehicle 200, when encountering an intersection 300, proceeds through the intersection 300 according to one of the formal linking entries. EPU 400 may transmit formal entries of link tables to host vehicles 200 but not transmit informal entries of link tables to host vehicles 200.

As previously discussed, EPU 400 may be configured to determine timing of the allowable driving maneuvers. Such timing may improve the quality of routing (discussed above) by enabling the navigation program to predict and thereby select the fastest route between the starting point and the destination.

To determine the timing, and at block 714, EPU 400 may parse the informal entries for the following sequence of events, described with reference to lane 301c (these operations may be applied to any lane of any intersection 300):

(1) A first host vehicle 200 is stopped at the end of lane 301c within a predetermined distance of crossing area 305, crosswalk 309, and/or a stopping line (not shown—but included in the base map) of lane 301c. The predetermined distance may be less than half the distance of a standard vehicle (e.g., less than 6 feet).

(2) First host vehicle 200 is stopped for at least a first predetermined amount of time (this step, as with all steps disclosed herein, is optional).

(3) After being stopped for at least the first predetermined amount of time, first host vehicle 200 executes the driving maneuver at issue (i.e., the driving maneuver being analyzed).

(4) A second host vehicle 200 continuously decelerates until stopping at the end of lane 301c within a predetermined distance of crossing area 305, crosswalk 309, and/or the stopping line within a predetermined time range of (1) occurring.

(5) Second host vehicle 200 is stopped for at least the first predetermined amount of time (this step, as with all steps disclosed herein, is optional).

(6) After being stopped for at least the first predetermined amount of time, second host vehicle 200 executes the driving maneuver at issue (i.e., the driving maneuver being analyzed).

After identifying the above sequence of events, EPU 400 may (a) subtract the time of the beginning of (3) from the time of the end of (4) and (b) subtract the time of the beginning of (3) from the time of the beginning of (6). These times may be found via interpolation along the continuous lines discussed above. Alternatively or in addition, and as stated above, host vehicle 200 may be configured to automatically generate a timestamp when (i) a sign of acceleration changes (i.e., positive to zero, zero to negative, negative to positive, etc.) and/or (ii) speed increases from zero.

A result of (a) is a possible length of time that the driving maneuver is allowed. A result of (b) is a possible cycle time (i.e., a possible length of time between an end of one allowed timespan and a beginning of a next allowed timespan). EPU 400 may perform these operations for a plurality of the same event sequences corresponding to the same lane and driving maneuver. EPU 400 may find the minimum plausible (a) and (b). The beginning of (6) may be an initial condition (discussed below).

The minimum plausible (a) may be the smallest recorded (a) that has occurred at least a predetermined number of times (occurrence accounting for slight variations—e.g., two recorded differences differing by less than predetermined percentage, such as 5%, may be considered to be the same recorded difference for these purposes), the predetermined number of times being based on the total recorded differences. According to some embodiments, the minimum plausible (a) is only set when a minimum number of event sequences (optionally, as with all features, within a certain time window) has been analyzed.

The minimum plausible (b) may be the smallest recorded (b) that has occurred at least a predetermined number of times (occurrence accounting for slight variations—e.g., two recorded differences differing by less than predetermined percentage, such as 5%, may be considered to be the same recorded difference for these purposes), the predetermined number of times being based on the total recorded differences. According to some embodiments, the minimum plausible (b) is only set when a minimum number of event sequences (optionally, as with all features, within a certain time window) has been analyzed.

Some intersections 300 have variable timing lights (e.g., lights that change when a vehicle is detected in a certain lane—such detection is often performed via a magnetism sensor or a weight sensor). Pedestrian traffic across crosswalks 309, 310, 311, 312 may substantially interfere with some driving maneuvers. For example, when traffic lights 306a, 306b, 306c are green, pedestrian traffic may impede a right turn from lane 301c into lane 303a, but not impede a forward driving maneuver that begins at lane 301c and ends at lane 302c.

As such, EPU 400 may be configured to determine when (i) lanes are governed by variable lights timings, (ii) when lanes are interfered with by pedestrian traffic, and (iii) when lanes are governed by fixed and thus predictable light timings.

EPU 400 may determine that (i) is true for a specific driving maneuver, when said maneuver is not associated with a minimum plausible (a) and/or (b) and no parallel lanes (parallel lanes, as used in the specification, but not necessarily the claims, refers to parallel lanes of the same road section) are associated with a minimum plausible difference. EPU 400 may determine that (ii) is true for a specific driving maneuver, when said maneuver is not associated with a minimum plausible (a) and/or (b) and at least one parallel lane is associated with (a) and/or (b).

The previously discussed link table may thus include, for each driving maneuver, formal timing entries. As shown in FIG. 8, formal timing entries comprise one of: (i) a marking that the driving maneuver is variable, (ii) a marking that the driving maneuver is impeded by pedestrian traffic, or (iii) the minimum plausible (a) and (b) and a starting point (called an initial condition). With reference to FIG. 8, a formal linking entry starting at lane 301a and ending at lane 302a is associated with (iii). The formal timing includes an initial condition (e.g., 12 am daily), a minimum plausible (a) (e.g., 15 seconds), and a minimum plausible (b) value (e.g., 32 seconds). EPU 400 may update the link table with formal timing entries at block 716. EPU 400 may upload the revised link table (optionally including the formal entries, but not any informal entries) to host vehicles 200 at block 718.

To find timing of allowable driving maneuvers, host vehicle 200 begins with the initial condition (e.g., 12 am), and then adds the minimum plausible (b) k number of times until: initial condition+k*(b)>time of entering crossing area 305. Host vehicle 200 now begins with the initial condition (e.g., 12 am), adds the minimum plausible (b) k−1 number of times, then adds (a).

If the initial condition+(b)*(k−1)+(a)<time of entering crossing area 305, then the allowed time of the driving maneuver is set as the range [initial condition+(b)*(k−1), initial condition+(b)*(k−1)+a]. Otherwise, the allowed time of the driving maneuver is set as the range of [initial condition+(b)*(k), initial condition+(b)*(k)+(a)].

A safety factor may be applied to prevent host vehicle 200 from entering the intersection immediately prior to the allowed time ending. When a safety factor (SF) is applied, the calculations may be computed as follows: If the initial condition+(b)*(k−1)+(a)−SF<time of entering crossing area 305, then the allowed time of the driving maneuver is set as the range [initial condition+(b)*(k−1), initial condition+(b)*(k−1)+(a)−SF]. Otherwise, the allowed time of the driving maneuver is set as the range of [initial condition+(b)*(k), initial condition+(b)*(k)+(a)−SF].

When the navigation program routes host vehicle 200 through an intersection 300 using a driving maneuver associated with (i), a warning may be generated (text, visual, or audio) prior to host vehicle 200 encountering intersection 300. Alternatively or in addition, a maximum speed of host vehicle 200 may be reduced through at least a portion of the driving maneuver. As stated above, revised link tables (optionally formal, but not informal entries) may be periodically and automatically issued to host vehicles 200. EPU 400 may be configured to update the initial conditions more frequently than (a) and (b).

The navigation program may rely on the formal the allowable driving maneuvers and the formal timing entries for route generation. Although the navigation program has been discussed within the context of a host vehicle 200, the navigation program may reside on a mobile device. Additionally, the above-discussed data may be collected from a mobile device alternatively or in addition to being collected from a host vehicle 200.

The methods and operations discussed above may be applied to a plurality of host vehicles 200 and a plurality of intersections 300, and each lane of the plurality of intersections 300. Additionally, EPU 400 may account for time of day, day of week, and/or month of year, etc. when determining allowable driving maneuvers and timings (discussed below) thereof. EPU 400 may account for these variables may adjusting the initial condition (discussed above).

Put differently, each intersection may include a plurality of link tables, each of the link tables corresponding to a different time of day (e.g., one link table may correspond to 8 am to 10 am Monday through Friday, but not Saturday or Sunday). When routing, host vehicle 200 may select the link table of a specific intersection 300 based on the time of day, day of week, and/or month of year when host vehicle 200 is expected to encounter the specific intersection 300 along the route.

Although the initial condition and minimum plausible (a) and (b) have been discussed as being identified by host vehicles 200 or mobile devices, these values may be preset and updated by an entity in control of traffic light timings.

EPU 400 may periodically request (by updating the above-described list) that host vehicles 200 confirm the integrity and accuracy of the formal timing entries. For example, EPU 400 may request that host vehicles 200 upload driving data corresponding to host vehicle 200 being stopped at an end of a lane, adjacent to crossing area 300, when (a) the stop occurs immediately before the driving maneuver corresponding to the formal timing entry is performed by host vehicle 200 and (b) the driving maneuver is expected to be allowed based on the formal timing entry corresponding to the driving maneuver. EPU 400 may perform an iterative process to tune the timing entries until a predetermined level of accuracy has been achieved (e.g., less than 5% of host vehicles 200 are stopped when the timing data would indicate otherwise). Other suitable tuning algorithms may be applied.

1. A vehicle comprising:
motor(s), sensors, processor(s) configured to:
periodically update a table with present coordinates;
compare the tabled coordinates to an intersection boundary;
select a portion of the tabled coordinates based on the comparison;
transmit the selected portion to an external unit.

2. The vehicle of claim 1, wherein the processor(s) are configured to: periodically connect a series of the tabled coordinates with a virtual and continuous line.

3. The vehicle of claim 2, wherein the processor(s) are configured to: determine whether any portion of the line falls within the intersection boundary, and if so, select the portion of the tabled coordinates.

4. The vehicle of claim 3, wherein the processor(s) are configured to: periodically query a list stored on the external unit and download the intersection boundary from the list.

5. The vehicle of claim 1, wherein the processor(s) are configured to: periodically query a list stored on the external unit and download the intersection boundary from the list.

6. The vehicle of claim 1, wherein the processor(s) are configured to receive a link table from the external unit, the link table comprising a beginning lane and a plurality of end lanes.

7. The vehicle of claim 6, wherein the processor(s) are configured to: generate a route of the vehicle based on the link table.

8. The vehicle of claim 7, wherein the processor(s) are configured to: generate the vehicle route based on the link table by routing the vehicle from the beginning lane to one of the plurality of end lanes.

9. The vehicle of claim 8, wherein the link table comprises a formal timing entry associated with each of the plurality of end lanes.

10. The vehicle of claim 9, wherein the processor(s) are configured to: generate the route based on at least one of the formal timing entries and wherein the external unit includes an external vehicle and an external server.

11. A host vehicle comprising:
motor(s), sensors, processor(s) configured to:
receive a series of entries, comprising coordinates and timestamps, from a first vehicle;
select entries corresponding to an identified traffic intersection based on the coordinates;
based on the selected entries, determine a driving maneuver of the first vehicle through the intersection and an intersection timing associated therewith.

12. The host vehicle of claim 11, wherein the intersecting timing is a length of time where the driving maneuver is forbidden.

13. The host vehicle of claim 12, wherein the processor(s) are configured to: search for, and select, entries where the host vehicle has a zero velocity and is within a predetermined distance of the intersection.

14. The host vehicle of claim 13, wherein the processor(s) are configured to: search for, and select, entries where the first vehicle has a positive velocity and has cleared the intersection.

15. The host vehicle of claim 14, wherein the processor(s) are configured to: determine the driving maneuver of the first vehicle through the intersection based on coordinates of the first vehicle after clearing the intersection.

16. A method of controlling a vehicle including motor(s), sensors, and processor(s), the method comprising, via the processor(s):
periodically updating a table with present coordinates;
comparing the tabled coordinates to an intersection boundary;
selecting a portion of the tabled coordinates based on the comparison;
transmitting the selected portion to an external unit.

17. The method of claim 16, comprising:
periodically connecting a series of the tabled coordinates with a virtual and continuous line;
determining whether any portion of the line falls within the intersection boundary, and if so, selecting the portion of the tabled coordinates;
periodically querying a list stored on the server(s) and downloading the intersection boundary from the list.

18. The method of claim 11, comprising: receiving a link table from the external unit, the link table comprising a beginning lane and a plurality of end lanes, the external unit comprising one or more external servers and one or more external vehicles.

19. The method of claim 16, comprising: generating a route of the vehicle based on the link table by routing the vehicle from the beginning lane to one of the plurality of end lanes, wherein the link table comprises a formal timing entry associated with each of the plurality of end lanes

20. The method of claim 19, comprising: generating the route based on at least one of the formal timing entries.
